(19) United States
(12) Patent Application Publication
(10) Pub. No.: US 2012/0161439 A1
(43) Pub. Date: Jun. 28, 2012

(54) HYDRAULIC FLANGE CONNECTION

(76) Inventor: Kapil V. Rajopadhye, Pune (IN)

(21) Appl. No.: 12/979,977

(22) Filed: Dec. 28, 2010

(51) Int. Cl. F16L 23/00

(52) U.S. Cl. 285/405

(57) ABSTRACT

A hydraulic flange connection formed on a tube having a first groove formed in the outside of the flange at a first stress area and a second groove formed in the outside surface of the flange at a secondary stress area and extending in a direction substantially perpendicular to a central cavity formed in the tube.

### FIELD OF THE INVENTION

The present hydraulic flange connection relates to a mechanical flanged connection primarily used in connection of a high pressure hydraulic line to a prime operator such as a hydraulic motor, pump or valve assembly. A circumferential secondary groove is located in an outside surface of the flange positioned to reduce the operational stresses of the flange connector thereby increasing its operational life.

### BACKGROUND OF THE INVENTION

Mechanical connections are used to connect high pressure hydraulic sources to prime movers such as a pump, motor or a valve assembly. One type of connector used in these applications is what is known as a flange. The Society of Automotive Engineers, through Standard J518, and the International Organization for Standardization, through standard 6162, have standardized on a flanged connector under the industry names of Code 61 or Code 62. The high hydraulic pressures handled by this type of connector necessarily includes pressure waves that increase the stress levels within the flanged connector that reduce the operational life of the connector. Also, mechanically induced bending loads which can result in cyclic fatigue and eventual failure. The prior art discloses a groove located in the surface of the connector at the area where the vertical and horizontal surfaces of the flange section and a transition section meet. This groove operates to lower the stress concentrations at this particular location on the connector where the vertical and horizontal surfaces meet to form the flange area. This method of reducing bending stresses is known in the art and has been used in hydraulic connectors and in other mechanical devices. The reduction of the sharp surface transition from the vertical to the horizontal by the introduction of the groove reduces the maximum bending stresses in the flange connector.

A method to reduce the bending induced stress in the flange connector will either reduce the thickness of the material required to make the connector and/or reduce certain dimensions of the flange section of the part to reduce the overall size is a desired improvement to the prior art.

### SUMMARY OF THE INVENTION

In order to improve the performance and reduce the material thickness and allow for alternative materials to be utilized in the manufacture and use of a flange connector, an improved flange connector is disclosed herein. This improved mechanical flange connector can be used to provide a fluid flow path and connect pressurized hydraulic system components, especially those experiencing high operating pressures.

Specifically, in terms of the structure of this improved flange connector, a circumferential second groove is formed in the flange approximately adjacent to a prior art first groove where in a first embodiment, the second groove is oriented approximately perpendicular to the longitudinal axis of the tube that is joined to and extends from the flange connector. The second groove significantly reduces the bending stresses in the section of the flange connector know as the flange section and specifically at the areas where there is a change in cross-sectional area. The circumferential first groove acts to reduce the stresses at that point where the cross-sectional area changes from that of the flange section to the transition section. However, the stresses can be further reduced with the introduction of this second groove in the transition section. The first groove is substantially circular in profile at its root while in the first embodiment, the second groove is shown as a “V” shaped groove.

In a first alternative embodiment, the circumferential second groove is enlarged and given a relatively large radius to further lower the stress level over that of the prior art designs. A typical radius for the first alternative second groove is approximately one third the radius of the tube section.

In a second alternative embodiment, the circumferential second groove is enlarged still further and the second groove is given a relatively larger radius to further lower the stress levels as compared to the prior art. The radius of the second groove for this second alternative embodiment is approximately one half the radius of the tube section.

Other shapes of either/or the first and second groove can be varied as necessary to facilitate manufacturing and to minimize the stresses in the flange connector to improve performance and packaging.

### BRIEF DESCRIPTION OF THE DRAWINGS

FIG. 1 is a cross-sectional view of a prior art flange connector;

FIG. 2 is a cross-sectional view of the flange connector having a second stress groove;

FIG. 3 is a sectional view of a portion of the flange connector of FIG. 2;

FIG. 4 is a perspective view of the flange connector of FIG. 2.

FIG. 5 is a cross-sectional view of a second embodiment of the flange connector;

FIG. 6 is a cross-sectional view of a third embodiment of the flange connector; and

FIG. 7 is a cross-sectional view of a fourth embodiment of the flange connector.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

Moreover, a number of constants may be introduced in the discussion that follows. In some cases illustrative values of the constants are provided. In other cases, no specific values are given. The values of the constants will depend on characteristics of the associated hardware and the interrelationship of such characteristics with one another as well as environmental conditions and the operational conditions associated with the disclosed system.

Now referring to FIG. 1 of the drawings, a cross-sectional view of a prior art flange connector 20 is shown. A tube section 21 is cast or otherwise formed with or attached to a flange section 22 though a transition section 28. The flange section 22 is mechanically attached to a hydraulic component such as a pump or motor or valve assembly to provide for a fluid connection and conduit path between such components. A seal groove 24 is shaped to accommodate a seal such as an O-ring. The O-ring (not shown) is trapped between the seal groove 24 and the hydraulic component (not shown) and is slightly compressed so as to provide a fluid seal there between. A central cavity 26 provides for the transport of a pressurized fluid such as hydraulic oil from a pressure source to the hydraulic (or fluid) component such as a pump, motor, etc. A transition section 28 is disposed between the tube section 21 and the flange section 22. When the flange connector 20 is subjected to pressure induced vibrations or otherwise structurally loaded by an attached hose or by the hydraulic component, bending stresses or other induced stresses can occur which can result in leakage of the transported fluid such as hydraulic fluid. In the prior art, the induced stresses are lowered with the incorporation of a circumferential first groove 30 located at the intersection of the flange section 22 and the transition section 28. In the drawings, a first groove 30 is shown having a radiused shape but many other types of shapes could be utilized to reduce the induced stresses at that location and otherwise in the flange connector 20.

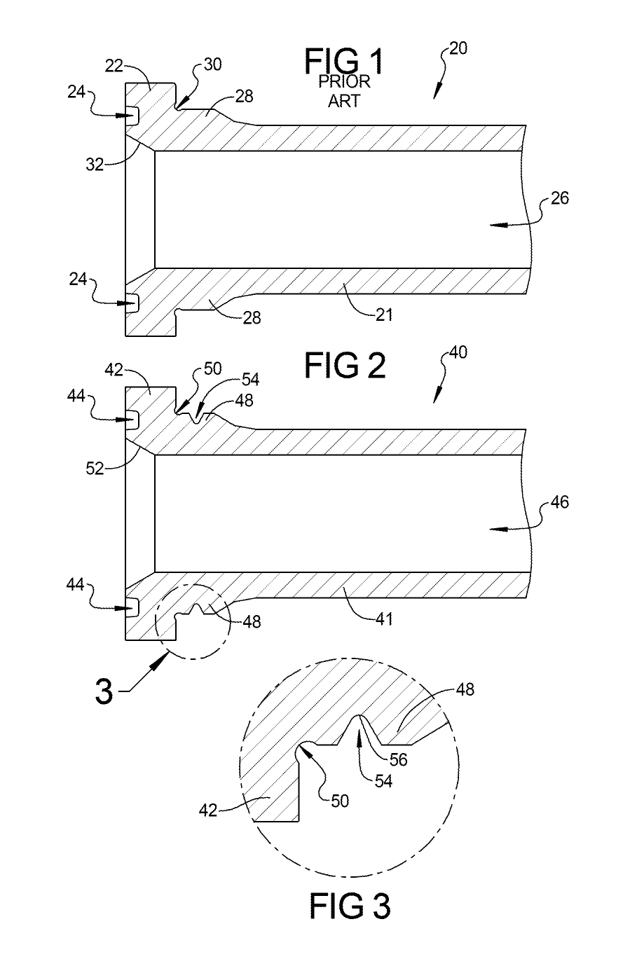

Now referring to FIG. 2, a cross-sectional view of an exemplary flange connector 40 having reduced levels of operationally induced stresses is shown. A tube section 41 is cast or otherwise formed with or attached to a flange section 42 through the transition section 48. The flange section 42 is mechanically attached to a hydraulic component such as a pump or motor or valve assembly. A circumferential seal groove 44 is shaped to accommodate a seal such as an O-ring. The O-ring (not shown) is trapped between the seal groove 44 and the hydraulic component (not shown) and is slightly compressed so as to provide a fluid seal there between. A central cavity 46 provides for the transport of a pressurized fluid such as hydraulic oil from a pressure source to the hydraulic (or fluid) component such as a pump, motor, etc. A transition section 48 is disposed between the tube section 41 and the flange section 42. When the flange connector 40 is subjected to pressure induced vibrations or otherwise structurally loaded by an attached hose or by the hydraulic component, bending stresses or other operational stresses can occur which can result in component failure and leakage of the transported fluid such as hydraulic fluid. The operationally induced bending stresses are lowered with the incorporation of a circumferential first groove 50 located at the intersection of the flange section 42 and the transition section 48. In the drawings, a first groove 50 is shown having a radiused shape but many other types of shapes could be utilized to reduce the induced stresses at that location and otherwise in the flange connector 40.

To further reduce the induced bending stresses in the flange connector 40, a circumferential second groove 54 is formed or machined in the transition section 48. The second groove 54 works in conjunction with the first groove 50 to minimize the induced stresses but the second groove 54 could be utilized by itself without a first groove 50 to reduce induced stress levels thereby improving performance of the flange connector 40.

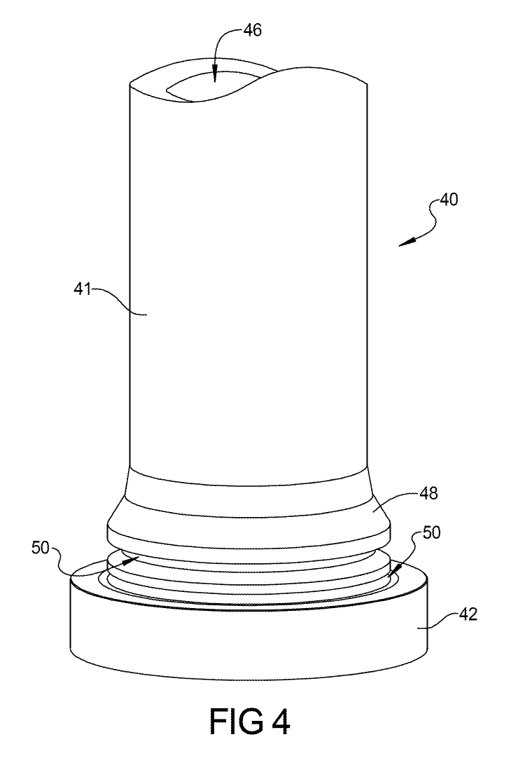

The shape of the second groove 54 is shown as having a “V” shape where the “V” has a radiused bottom section 56 to minimize stresses. This is more clearly shown in FIG. 3 of the drawings. Even though the shape of the second groove 54 is shown as having a “V” shape, many other shapes for the second groove 54 could be utilized to lower the level of stresses within the flange connector 50. Two alternate embodiments that use other shapes for the second groove 54 are shown with reference to FIGS. 4 and 5. For example, a “U” shape could be utilized if that would be more easily manufactured or if it was shown to reduce the level of the induced bending stresses in the flange connector 40.

Now referring to FIG. 3 of the drawings, a portion of the flange connector 50 of FIG. 2 is shown where both the first and second grooves 50, 54 are enlarged for clarity of illustration. More clearly shown is the radiused bottom section 56 of the second groove 54 that further lowers the induced stress level. Also more clearly shown is the radiused shape of the first groove 50. The first and second grooves 50, 54 are located between the flange section 42 and the transition section 48.

Now referring to FIG. 4 of the drawings, a perspective view of the flange connector 40 is shown and this figure clearly shows how the first and second grooves 50, 54 are circumferential in shape. The first groove 50 is located at the root of the mounting flange 42 and is located between the mounting flange 42 and the second groove 54. The second groove 54 is located between the first groove 50 and the transition section 48 which is joined to the tube section 41. The contour of the first groove 50 is radiused to lower stress levels in that particular area of the flange connector 40. To further reduce stress levels in the flange connector 40, a second groove 54 is formed in the area between the first groove 50 and the tube 41. The stress level under specific conditions is lowered from 511 Mpa for the prior art configuration shown in FIG. 1 down to 467 Mpa for this configuration shown in FIGS. 2-4.

Now referring to FIG. 5 of the drawings, a cross-section of a first alternate embodiment of the flanged connector 60 is shown. The shape and the orientation of the second groove 74 has been modified to lower the maximum stress in the area of the second groove 74 down to 408 Mpa under the specified conditions. Flange connector 60 has reduced levels of induced bending stresses which can result in structural and operational benefits such as the use of thinner walled sections and/or improved life expectancy or higher operating pressures. A tube section 61 is cast or otherwise formed with or attached to a flange section 62. The flange section 62 is attached to a hydraulic component such as a pump or motor or valve assembly. A circumferential seal groove 64 is shaped to accommodate a seal such as an O-ring. The O-ring (not shown) is trapped between the seal groove 64 and the hydraulic component (not shown) and is slightly compressed so as to provide a fluid seal there between. A central cavity 66 provides for the transport of a pressurized fluid such as hydraulic oil from a pressure source to the hydraulic (or fluid) component such as a pump, motor, etc. A transition section 68 is disposed between the tube section 61 and the flange section 62. When the flange connector 60 is subjected to pressure induced vibrations or otherwise structurally loaded by an attached hose or by the hydraulic component, bending stresses or other induced stresses can occur which can result in leakage of the transported fluid such as hydraulic fluid. These induced stresses are lowered with the incorporation of a circumferential first groove 70 located at the intersection of the flange section 62 and the transition section 68. In FIG. 5, a first groove 70 is shown having a radiused shape but many other types of shapes could be utilized to reduce the induced stresses at that location and otherwise in the flange connector 60.

To further reduce the bending and other induced stresses in the flange connector 60 a circumferential second groove 74 is formed or machined adjacent to the transition section 68. The second groove 74 works in conjunction with the first groove 70 to minimize the induced stress levels but the second groove 74 could be utilized by itself without a first groove 70 to reduce induced stress levels thereby improving performance of the flange connector 60. The shape of the second groove 74 is shown as having a “dished out” shape where the second groove 74 lowers the stress level down to 408 Mpa when used in conjunction with the first groove 70 although it could be used individually to lower the stress levels in the flange connector 60. The second groove 74 has a radius of approximately one third of the radius of the tube section 61.

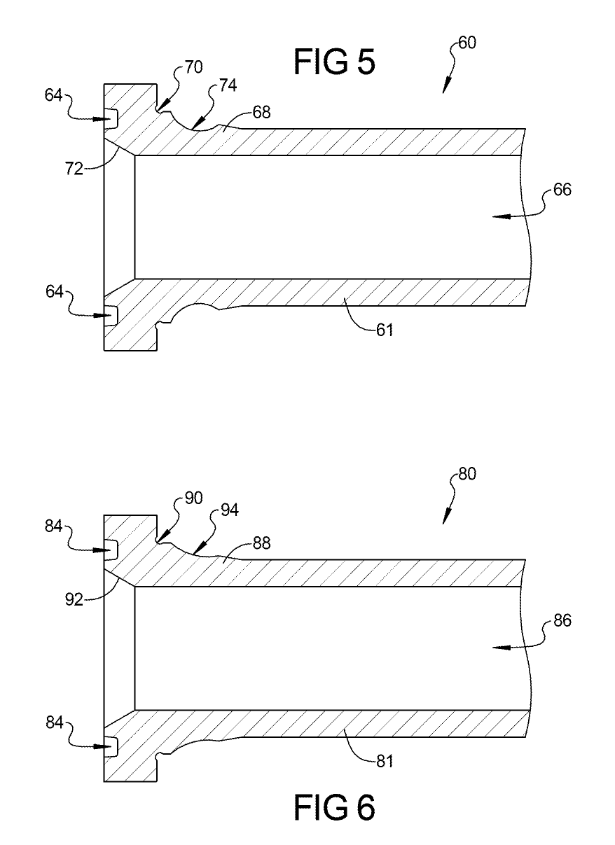

Now referring to FIG. 6, a cross-sectional view of a second alternative embodiment of the exemplary flange connector 80 having reduced levels of induced stress is shown. A tube section 81 is cast or otherwise formed with or attached to a flange section 82. The flange section 82 is attached to a hydraulic component such as a pump or motor or valve assembly. A circumferential seal groove 84 is shaped to accommodate a seal such as an O-ring. The O-ring (not shown) is trapped between the seal groove 84 and the hydraulic component (not shown) and is slightly compressed so as to provide a fluid seal there between. A central cavity 86 provides for the transport of a pressurized fluid such as hydraulic oil from a pressure source to the hydraulic (or fluid) component such as a pump, motor, control valve, header, etc. A transition section 88 is disposed between the tube section 81 and the flange section 82. When the flange connector 80 is subjected to pressure induced vibrations or otherwise structurally loaded by an attached hose or by the hydraulic component, bending stresses or other induced stresses can occur which can result in leakage of the transported fluid such as hydraulic fluid. The induced stresses are lowered with the incorporation of a circumferential first groove 90 located at the intersection of the flange section 82 and the transition section 88. In the drawings, the first groove 90 is shown having a radiused shape but many other types of shapes could be utilized to reduce the induced stresses at that location and otherwise in the flange connector 80.

To further reduce the operationally induced mechanical stresses in the flange connector 80, a circumferential second groove 94 is formed or machined in the transition section 88 between the first groove 90 and the tube section 81. The second groove 94 works in conjunction with the first groove 90 to minimize the induced stresses but the second groove 94 could be utilized by itself without a first groove 90 to reduce induced stress levels thereby improving performance of the flange connector 80.

The shape of the second groove 94 is shown as having a bowl shape with a relatively large radius especially when compared to the shape of the second groove 34 shown in FIG. 2. In fact, the radius of the second groove 94 in FIG. 6 is noticeably larger than that of the second groove 74 shown in the first alternative embodiment as shown in FIG. 5. The radius of the second groove 94 is approximately one half of the radius of the tube section 81. The stress level under the same specified conditions is lower than the stresses predicted in the flanged connector of FIG. 5.

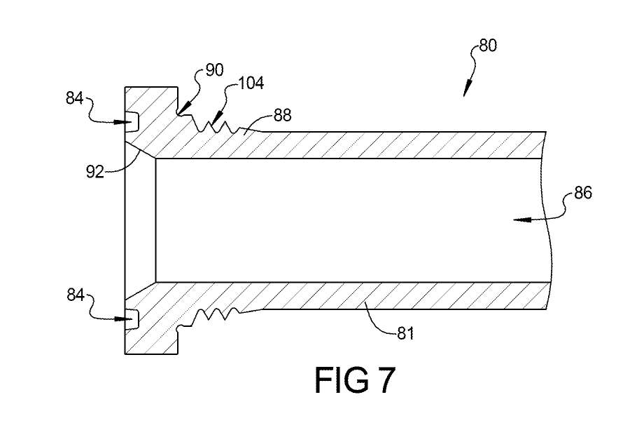

As shown in FIG. 7, the second groove 94 can be replaced by a plurality of secondary circumferential grooves 104 that are similar in shape to the second groove 94 or they can be narrower width grooves. The secondary circumferential grooves 104 can be of the general size and of a general shape of the first groove 90 or the second groove 54. The exact number and shape are dependent on the geometry of the flange 42 and tube 41 and the application parameters under which the flange 40 is being used. The secondary grooves 104 can be of the same shape or they can vary in shape and depth.

The present disclosure has been particularly shown and described with reference to the foregoing illustrations, which are merely illustrative of the best modes for carrying out the disclosure. It should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing illustrations are illustrative, and no single feature or element is essential to all possible combinations that may be claimed in this or a later application.

I claim:

1. A fluid connector having a flange section and a transition section, said fluid connector having at least one circumferential groove formed thereon at the intersection of the flange section and the transition section to minimize the bending stress levels in the fluid connector when the fluid connector is subjected to operating pressures and vibration inputs.

2. The fluid connector of claim 1, wherein said circumferential groove is disposed between a flange section and a tube section.

3. The fluid connector of claim 1, wherein said circumferential groove has a central axis that is oriented at anapproximate of 45 degrees to a connector central passageway.

4. The fluid connector of claim 1, wherein said circumferential groove has a partial circular cross-sectional shape.

5. A fluid connector having a flange section joined to a transitional section and a tube section, said flange section having a first circumferential groove and a second circumferential groove where said first circumferential groove is located between said mounting flange section and said second circumferential groove is located between said first circumferential groove and said transition section.

6. The fluid connector of claim 5, wherein said second circumferential groove includes a radiused section at a nose section of said second circumferential groove.

7. The fluid connector of claim 5, further comprising a tube section joined to said transition section.

8. The fluid connector of claim 5, further comprising a second circumferential groove where said second circumferential groove is located between said flange mounting section and a first circumferential groove where said first circumferential groove is located between said second circumferential groove and said tube section and where said second circumferential groove has a principal axis that is approximately perpendicular to a central axis of said fluid connector.

9. The fluid connector of claim 7, wherein said first and second circumferential gooves each have a central axis that are at least 20 degrees apart.

10. The fluid connector of claim 5, further comprising a second circumferential groove where said second circumferential groove is located between said flange mounting section and a first circumferential groove where said first circumferential groove is located between said second circumferential groove and said tube section and where said second circumferential groove has a principal axis that is approximately perpendicular to a central axis of said fluid connector.

11. The fluid connector of claim 5, further comprising a plurality of secondary circumferential groove s where said secondary circumferential grooves are located between said flange mounting section and a first circumferential groove where said first circumferential groove is located between said secondary circumferential grooves and said tube section and where said secondary circumferential grooves have a principal axis that is approximately perpendicular to a central axis of said fluid connector.
